(19) United States
(12) Patent Application Publication
(10) Pub. No.: US 2011/0010944 A1
(43) Pub. Date: Jan. 20, 2011

(54) TOOL FOR ACCESS TO OPTICAL FIBRES

(76) Inventors: Arnaud Le Dissez, Milano (IT); Alessandro Pirri, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/811,370

(22) PCT Filed: Dec. 9, 2008
(86) PCT No.: PCT/EP08/67146

§ 371 Date: Oct. 4, 2010

(30) Foreign Application Priority Data
Jan. 4, 2008 (IT) MI2008A000008

(51) Int. Cl. G02B 6/245; H02G 1/12

(52) U.S. Cl. 30/90.4

(57) ABSTRACT

A tool for access to optical fibres contained within a cable includes: a body having a longitudinal recess along a longitudinal axis, conceived to partially contain a section of cable; and a blade having a cutting edge fixed transversally inside the recess set at a predetermined slant in relation to the longitudinal axis of the recess.

The present invention relates to a tool for access to optical fibres contained inside a monotube type cable for optical fibres, according to the preamble of the main claim.

The use of optical fibres as a transmission means is conventionally known in prior art. To protect said optical fibres during installation and successive set-up, it is a known practice to house a plurality of fibres inside cables for monotube optical fibres.

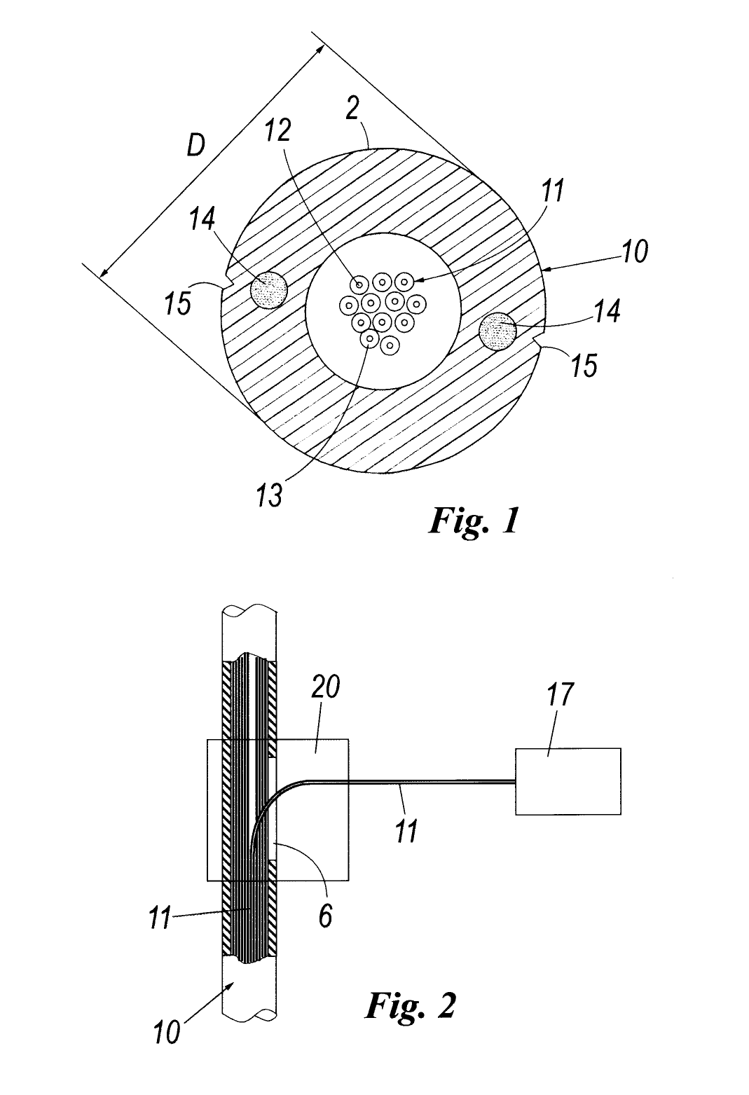

FIG. 1 shows a transversal section of a conventionally known cable for optical fibres 10 comprising a tube 2 that forms an internal channel wherein a plurality of optical fibres 11 is contained. Each optical fibre 11 comprises a transmission nucleus 12 coated with at least one layer of polymer coating 13. Reinforcing elements 14 are also included in the thickness of the tube wall 2 to provide the cable with the mechanical properties required for its intended use.

The tube 2 is generally made from a thermoplastic material, and the reinforcing elements 14 are made of fibre glass, for example.

For added convenience, grooves 15 are created on the external surface of the cable 10 in proximity to the reinforcing elements 14 in order to simplify the identification of their position.

In a typical application, the cables 10 containing the optical fibres 11 are laid along the walls of a building, often with long sections in a vertical direction.

As shown in FIG. 2, openings 6 are created in said cables 10 to provide access to an optical fibre 11 positioned inside a cable 10, for example, in such a manner so that the said optical fibre 11 can be extracted from the cable in question and delivered to the end user 17.

U.S. Pat. Nos. 5,140,751 and 5,577,150 describe tools for access to optical fibres. Said tools completely enclose the sheath wherein the openings are to be made and therefore, especially when cables are fixed to a support, said tools are cumbersome to use.

The Applicant approached the problem of providing a tool for rapid access to optical fibres contained within a monotube, including those cases wherein the monotube is already fixed to a support.

According to the present invention, the Applicant has provided a tool for access to optical fibres contained within a cable, characterised in that it comprises:
a body 1a having a longitudinal recess 1b along a longitudinal axis, conceived to partially contain a section of cable 10; and
a blade 3 having a cutting edge 3a, fixed transversally inside said recess 1b set at a predetermined slant in relation to the longitudinal axis of said recess 1b.

Preferably, the tool according to the invention comprises a gripping means attached to the body. Said gripping means can also include a handle.

Said handle can be set in a slanted position in relation to the longitudinal axis of the longitudinal recess.

Alternatively, said handle can be set perpendicular to the longitudinal axis of the longitudinal recess.

In a preferred embodiment, the body of the tool of the invention has a substantially U-shaped transversal section, to define the internal sidewalls between which the blade is fixed.

Advantageously, the blade of the tool forms an acute angle in relation to the longitudinal axis of the longitudinal recess.

Preferably, said angle is comprised between 10° and 40°.

In a preferred application, spacer elements are present within the recess to adapt the body to cables having different diameters.

Preferably, the tool according to the invention has a body with rounded edges on at least one end.

Advantageously the body of the tool is made from a plastic material.

Further details are provided in the following description of an embodiment shown in the appended drawings wherein:

FIG. 1 shows a sectional view of a conventionally known cable for optical fibres, comprising a tubular element containing a plurality of optical fibres;

FIG. 2 shows a system comprising optical fibres contained within a tubular cable of the type shown in FIG. 1;

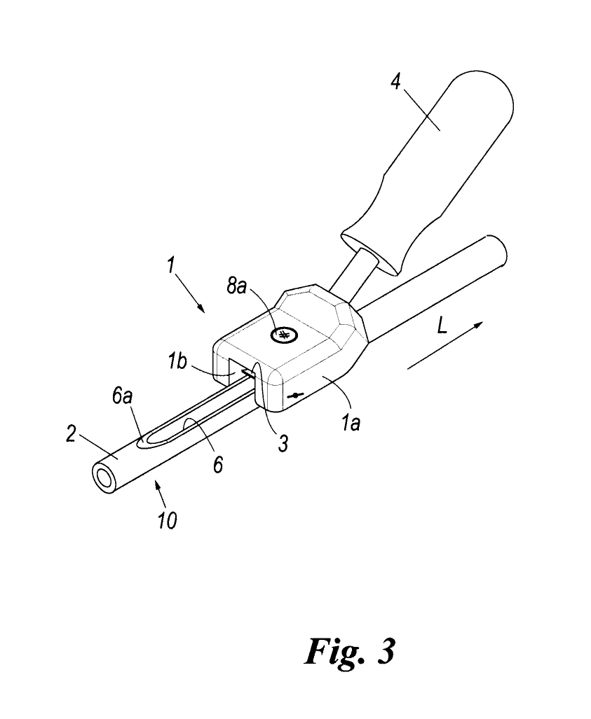

FIG. 3 shows a perspective view of a first embodiment of a tool according to the invention, when in use;

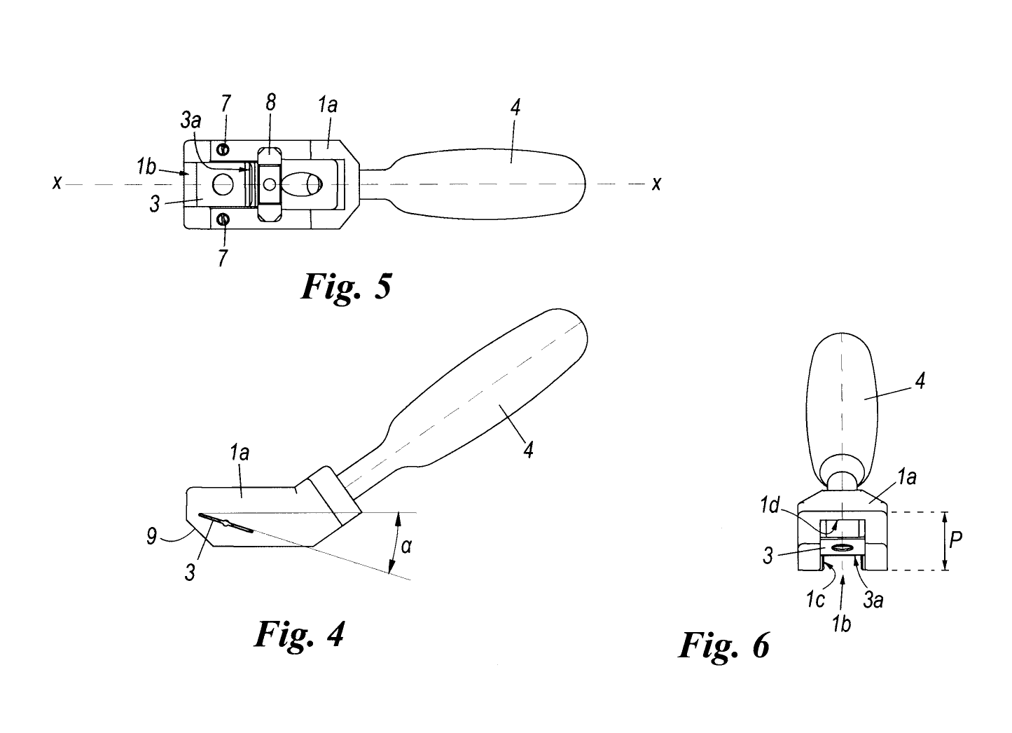

FIGS. 4 to 6 show respective side, bottom and front views of the tool shown in 3;

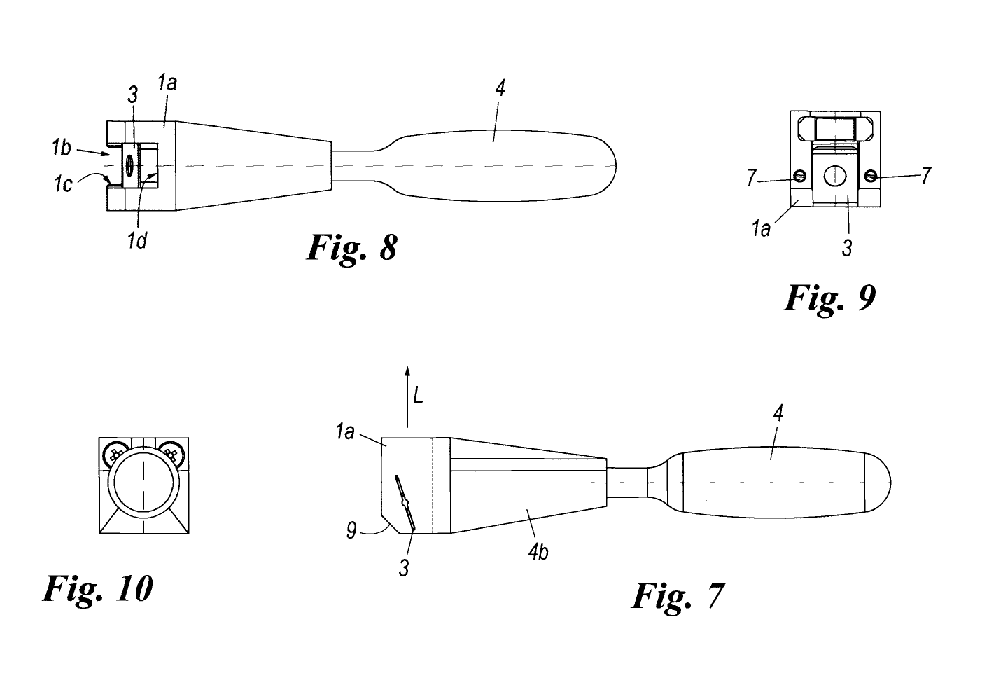

FIGS. 7 to 10 show respective side, bottom, front and rear views of a second embodiment of the tool of the invention.

With reference to FIG. 3, a tool 1 is applied onto the tube 2 of an optical fibre cable 10 for access to the optical fibres, which are contained therein.

The tool 1 comprises a body 1a having a longitudinal recess 1b for the partial housing of a section of the cable 10.

A blade 3, having a cutting edge 3a, visible in FIG. 5, is attached to the body 1a, crossing said recess 1b on a slant α in relation to the longitudinal axis x-x of the recess 1b.

When the tool is applied on the cable 10, in a manner so that it is positioned inside the recess 1b, the blade 3 penetrates the cable 10.

The body 1a of the tool 1 comprises a handle 4, or some similar gripping means, to permit its manoeuvring.

In particular, in the embodiment of the invention shown in FIG. 3, the handle 4 is positioned on a slant in relation to the extension direction of the section of cable 10 wherein the opening 6 is to be performed.

The recess 1b of the body 1a has a U-shaped section, defining the internal sidewalls 1c and an end wall 1d. The blade 3 is fixed between the internal sidewalls 1c.

The blade 3 has a typically rectangular shape and can be of the replaceable type.

The blade 3 is fixed to the body la of the tool by fixing means, preferably removable, such as screws 7, rivets, or similar fixing means, for example.

The blade 3 forms an acute angle a in relation to the longitudinal axis x-x of the recess 1b. Preferably, the angle α is comprised between 10° and 40°, ends included. The cutting edge 3a faces the open area towards the exterior of the recess 1b.

Advantageously, the distance between the sidewalls 1c is basically equal to the external diameter D of the largest sized foreseen cable 10 (for example: a cable containing 48 optical fibres). The cutting edge 3a of the blade 3 is positioned at a distance from the end wall ld of the recess, which is less than half of the external diameter D of the largest sized foreseen cable 10 that can be used with the tool according to the invention.

Spacer elements 8 can be foreseen within the longitudinal recess 1b to adapt the body 1a to the various diameters of cable 10.

For example, these spacer elements 8 are specifically shaped elements with a basically U-shaped recess, which are inserted within the recess 1b, to reduce the depth P of the recess 1b, in question.

Said spacer elements 8 are dimensioned in relation to a corresponding cable size, which measures less than the maximum size, or in relation to a group of cable sizes, in such a manner that the distance from the end wall defined by the spacer element is less than half of the external diameter D of said cable of a lesser size.

Said spacer elements 8 can be fixed to the body by press-fitting or fixed joint, or by means of removable fixing elements, such as a screw 8a, for example.

In an alternative embodiment, not illustrated herein, the longitudinal recess 1a can have a transversal section with a semicircular or triangular shape, or some other form, suitable to contain the cable in a controlled position.

Advantageously, the body of the tool according to the invention can be made from a plastic material, produced by a moulding process, for example.

The creation of the opening in the tube 2 of the cable 10 occurs in the following manner.

The tool 1 is positioned over the cable 10, housing the cable in question within the longitudinal recess 1a, as shown in FIG. 3.

By exercising controlled pressure on the cable, the tool is pulled along the cable 10 in question, in the cutting direction L, parallel to the axis of cable 10 (or at least, to the axis of the section of cable 10 that requires the cutting of an opening).

In this manner, the blade 3 progressively penetrates through the tube wall 2, as far as defined by the depth of the recess 1b (or by the spacer element 8 that corresponds with the size of the cable on which it is operating) and removes a portion of the tube wall 2 in question, thus creating an opening 6.

In this manner, an opening 6 is formed having a substantially rectilinear longitudinal profile, parallel to the axis of the tube 2, connected to an oblique entry portion 6a and to a corresponding exit portion, not illustrated herein.

The tool according to the invention can be advantageously used on cables 10 that present a pair of longitudinal reinforcing elements 14 set into the thickness of the tube wall 2 in diametrically opposite positions, without the blade 3 tampering with said reinforcing elements, since the distance between the cutting edge 3a of the blade in question, and the end wall 1d of the recess 1b limits the blade penetration in the tube wall 2, in a controlled manner.

Figures from 7 to 10 show a second embodiment of the tool according to the invention.

All elements of the tool having the same characteristics and functions, as the tool 1 of the first embodiment will be identified with the same reference numbers.

Advantageously, according to this embodiment, the tool 1 comprises a handle 4 mechanically connected to the body 1a and substantially positioned perpendicular to the axis of the recess 1b, in turn parallel to the cutting direction L.

The body 1a is a specifically shaped element comprising a longitudinal recess 1b, with a U-shaped transversal section defining sidewalls 1c and an end wall 1d.

The blade 3 is fixed to the body la through the recess 1b and is fixed to the body 1a by means of screws 7 or similar means, for example.

A connecting element 4b connects the handle 4 to the body 1a in a fixed manner.

Advantageously, the connection 4b is an integrated part of the body 1a.

Said embodiment of the tool 1 according to the invention is particularly advantageous when the cable 10 is housed inside a box 20, as shown schematically in FIG. 2.

In fact, in this embodiment, the tool 1 can be produced with very compact dimensions, suitable to permit access to the cable even when the cable portion in question requiring intervention is contained in a compartment of reduced size.

Advantageously, as shown in FIGS. 4 and 7, for example, the rear end of the body (in relation to the cutting direction L) has rounded edges conceived to facilitate the release of the tool 1 from the cable 10 after the cutting operation of the opening 6 has been completed.

In conclusion, the tool according to the invention permits rapid access to the optical fibres contained in monotube cables, providing very regular shaped openings, even when said cables are fixed to a support or are contained inside a box element, even of a reduced size.

1-11. (canceled)

12. A tool for access to optical fibres contained in a cable, comprising:
a body having a longitudinal axis, conceived to partially contain a section of the cable; and
a blade having a cutting edge fixed transversally in said recess at a predetermined slant in relation to the longitudinal axis of said recess.

13. The tool according to claim 12, comprising a gripping means fixed to form part of the body.

14. The tool according to claim 12, wherein the body has a substantially U-shaped transversal section defining internal side walls between which the blade is fixed.

15. The tool according to claim 12, wherein the blade forms an acute angle in relation to the longitudinal axis of the longitudinal recess.

16. The tool according to claim 15, wherein the angle is between 10° and 40°.

17. The tool according to claim 12, wherein spacer elements are present within the recess to adapt the body to cables of various diameters.

18. The tool according to claim 13, wherein the gripping means comprises a handle.

19. The tool according to claim 18, wherein the handle is set on a slant in relation to the longitudinal axis of the longitudinal recess.

20. The tool according to claim 18, wherein the handle is perpendicular in relation to the longitudinal axis of the longitudinal recess.

21. The tool according to claim 12, wherein the body has one end with rounded edges.

22. The tool according to claim 12, wherein the body is made from a plastic material.
